(19) United States
(12) Patent Application Publication
(10) Pub. No.: US 2026/0191143 A1
(43) Pub. Date: Jul. 9, 2026

(54) Windguard Assembly for an Agricultural Baler

(71) Applicant: AGCO Corporation, Duluth, GA (US)

(72) Inventors: Stephen Samuel McMaster, Hesston, KS (US); Kelly B. Booton, Hesston, KS (US); Patrick L. Cherney, Hesston, KS (US)

(21) Appl. No.: 19/128,559

(22) PCT Filed: Oct. 17, 2023
(86) PCT No.: PCT/IB2023/060477

§ 371 Date: May 8, 2025

Related U.S. Application Data
(60) Provisional application No. 63/383,408, filed on Nov. 11, 2022.

(51) Int. Cl. A01D 89/00

(52) U.S. Cl. CPC A01D 89/008; A01D 89/001

(57) ABSTRACT

The present invention relates to a windguard assembly for use with an agricultural baler (2), the assembly comprising a guide channel (30), a carriage (40) with a base element (42) for displacement within the guide channel, a windguard frame element (60) supported by the carriage and a crop material hold down element (70) supported frame element. In a working position the guide channel is secured to a lower side of a baler frame and free ends of the frame element are secured to a pick up housing forming part of the agricultural baler. In the event of a blockage within the pick up apparatus, or to allow access for maintenance of the pick up apparatus, the free ends of the frame element may be disconnected from the pick up housing allowing frame element together with the crop material hold down element to be displaced away from the pick up apparatus.

### CROSS-REFERENCE TO RELATED APPLICATIONS

Not applicable.

### FIELD

The present invention relates to a windguard assembly for use with an agricultural baler, such as a hay baler, and to an agricultural baler having such a windguard assembly.

### BACKGROUND

A windguard is adapted to be attached to a frame of a crop pickup in overlying relationship to a pick up tine rotor so as to control the incoming flow of harvested crop material. Typically, such windguards are attached to a body or frame of a baler by pins, bolts or like. In particular, the windguard allows for a more even feeding of a harvested crop mat into the baler allowing for more consistent baling.

Nevertheless, from time to time blockages arise in the feeding mechanism of the baler. On such occasions it is necessary to access the baler and the secure location of such windguards interferes with the ease of such access. In particular, removal of the windguard from the baler frame is a time consuming task as is restoring the windguard to the required position on the baler frame once the blockage has been cleared.

It is an advantage of the present invention that this problem is addressed.

It is known from U.S. Pat. No. 7,654,069 (Vermeer) to provide slots in the side panels of a baler allowing for limited movement of the windguard between a forward position and a rearward position. However, this construction does not permit sufficient movement of the windguard to access the baler for clearing of blockages or other tasks.

### BRIEF SUMMARY

According to a first aspect of the present invention, a windguard assembly for use with an agricultural baler is disclosed, the windguard assembly comprising a guide channel for connection to an agricultural baler, a carriage for displacement within the guide channel, a windguard frame element supported by the carriage and a crop material hold down element pivotally supported from the windguard frame element about a pivot axis wherein the guide channel includes L-shaped flanges adapted to support the carriage and allow for displacement of the carriage within the guide channel.

Preferably, the carriage further comprises side walls connected to a base element and runners supported by the side walls, the runners being housed with the guide channel.

Preferably, the windguard frame element is supported from the carriage and comprises first and second support arms connected by a transversely extending member.

Preferably, the windguard frame element is supported from the carriage and comprises first and second support arms connected by a transversely extending member. More preferably, the carriage further comprises a tubular support element connected to a base of the carriage through which the transversely extending member extends.

Preferably, the crop material hold down element comprises a laterally extending element carrying a plurality of elongate tines. More preferably, the laterally extending element of the crop material hold down element is supported from the transversely extending member of the windguard frame element by a linkage.

Preferably, the linkage comprises first and second tabs on the laterally extending element of the crop material hold down element, first and second tabs on the transversely extending member of the windguard frame element, upper ends of the respective first and second tabs being connected to one another by pivot pins to allow movement about the pivot axis.

Preferably, the assembly further comprises fasteners for securing the windguard frame element to an agricultural baler.

According to a second aspect of the invention, an agricultural baler comprises a windguard assembly according to a first aspect of the invention.

Preferably, the baler comprises a baler frame having a lower part and support elements depending from the baler frame wherein the guide channel of the windguard assembly is secured to the lower part of the baler frame, the windguard frame element and the crop material hold down element are releasably connected to lower ends of the support elements and the baler further comprises a pickup apparatus having a pick up housing wherein the windguard frame element is releasably secured to the pick up housing.

Within the scope of this application it should be understood that the various aspects, embodiments, examples and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

### BRIEF DESCRIPTION OF THE DRAWINGS

The invention will now be described, by way of example only, with reference to the accompanying drawings, in which:

FIG. 1 shows a side view of a known agricultural baler having a fixed windguard;

FIG. 2 shows a side view of a part of an agricultural baler incorporating a windguard assembly in accordance with the present invention;

FIG. 3 shows a perspective view of elements of a baler incorporating a windguard assembly in accordance with the present invention;

FIG. 4 shows a detail of the connection of a windguard support to the baler frame;

FIG. 5 shows a detail of the connection of a windguard frame to the windguard support;

FIG. 6 shows a perspective view of a windguard assembly in accordance with the present invention connected to elements of a baler frame;

FIG. 7 shows a further perspective view of a windguard assembly in accordance with the present invention connected to elements of a baler frame;

FIG. 8 shows a still further perspective view of a windguard assembly in accordance with the present invention connected to elements of a baler frame and

FIG. 9 shows a detail of an agricultural baler with the windguard assembly in place.

### DETAILED DESCRIPTION

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description.

Unless made clear by the context, references to a front end or forward direction are understood to be references to the front of the agricultural baler when being towed by a suitable agricultural vehicle.

Like reference numerals are used to refer to like parts throughout.

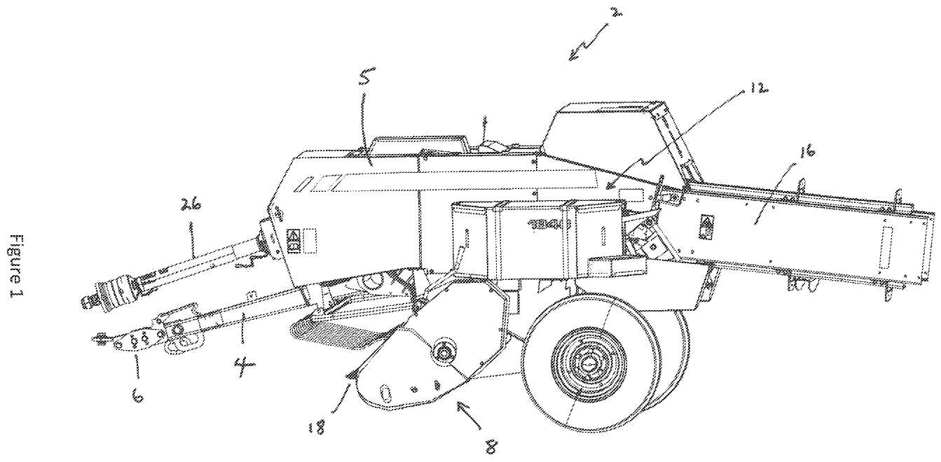

With reference to FIG. 1, a known agricultural baler 2 is shown with a fixed windguard to provide a context for the use of windguards. In the illustrated embodiment, the baler 2 is of the ‘extrusion’ type in which harvested crop material is gathered into the baler and compressed into parallelepiped bales (known as square bales). The invention may also be applied to a round baler. In each case, the agricultural baler 2 comprises a baler frame including a fore and aft extending tongue 4 to which various baler and baler housing elements may be secured. The tongue 4 may be considered to form a lower part of the baler frame. An upper part 5 of the baler frame includes a framework to which the baler housing elements may also be secured together with outer casing elements supported on the framework to shield the baler housing elements. A front end of the tongue 4 is provided with a suitable hitch 6 to connect the agricultural baler 2 to a towing vehicle such as tractor.

The baler housing elements mounted to the baler frame house a variety of operational elements. These elements include a pick up apparatus 8, a charge forming duct 10 and a baling chamber 12. Harvested crop material is gathered from the ground and directed to the charge forming duct 10 prior to admission into the baling chamber 12 where the harvested crop material is compressed into a formed bale. The charge forming duct 10 extends generally rearwardly and upwardly from a point just behind the pickup apparatus 8 to a gated opening provided in a bottom surface of the baling chamber. As best shown in FIG. 3 the agricultural baler 2 may also include twin stub augers 14 located within a lower end of the charge forming duct 10, each auger 14 being located to one side of the charge forming duct 10 and configured to draw harvested crop material towards a central longitudinal axis of the agricultural baler 2 prior to the harvested crop material being directed along a chute forming part of the charge forming duct 10 to the baling chamber 12. A set of packing forks typically operate within the chute to form a charge of harvested crop material and then insert this charge into the baling chamber 12.

During operation of the agricultural baler 2, successive charges of harvested crop material are introduced into the baling chamber 12 by way of the gated opening and compacted together under the action of a reciprocating plunger operating within the baling chamber 12. In this way a formed bale is built up by subsequent compressions of charges of harvested crop material. Once the formed bale is of a desired size, a knotting mechanism is actuated to tie off the formed bale before a subsequent bale starts forming within the baling chamber 12. As each new formed bale is being created, the previously formed bale is urged from the baling chamber 12 along an ejection chute 16 until the formed bale is expelled from the agricultural baler 2.

In such an agricultural baler 2, the reciprocating plunger is located above the tongue 4 and toward a front end of the agricultural baler 2. The baling chamber 12 is located above the tongue 4 toward the rear end of the agricultural baler 2. The pick up apparatus 8 comprises a driven rotating tine rotor 18 supported in a pickup housing 20. The driven rotating tine rotor 18 extends transversely across the agricultural baler 2 below the tongue 4.

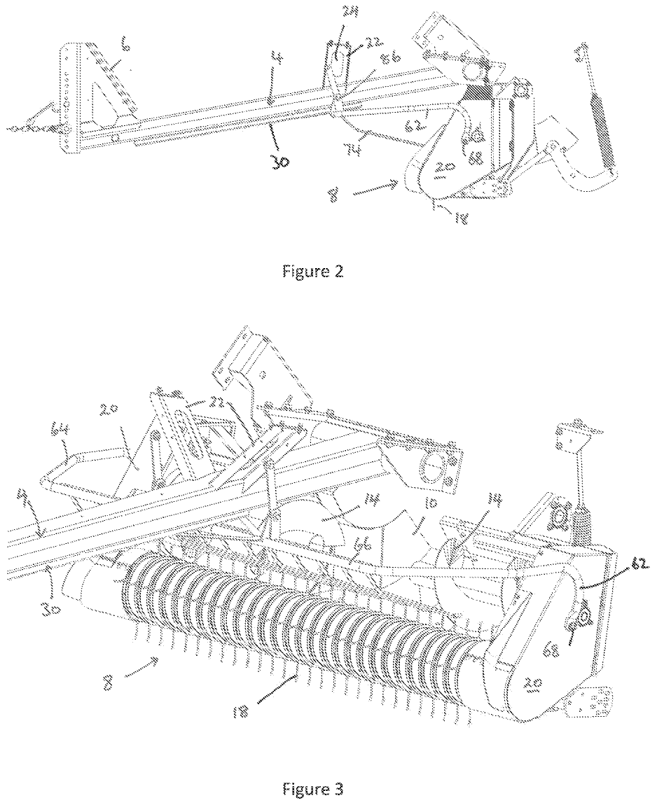

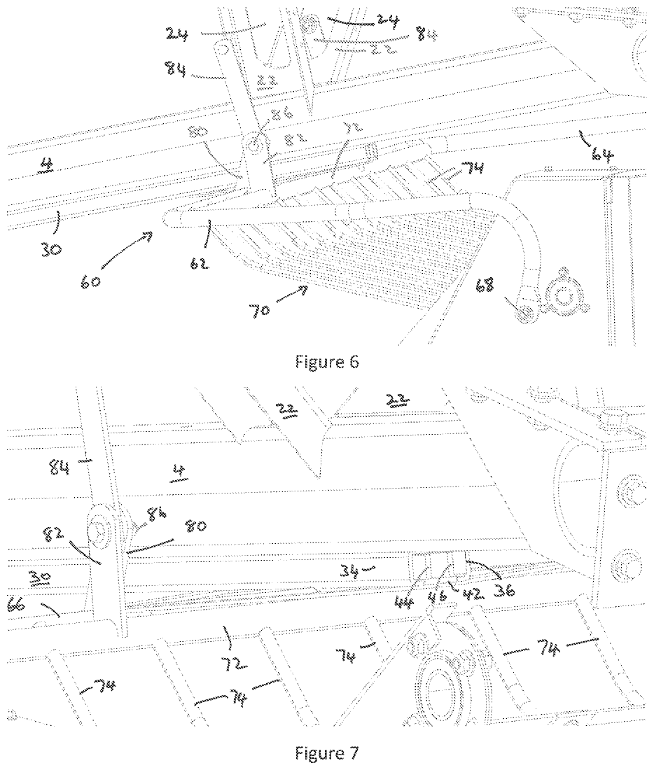

The tongue 4 is provided at a predetermined location at each side with first and second upwardly extending brackets 22 connecting the tongue 4 to a portion of the baler housing. In the illustrated embodiment show in FIGS. 2 to 8, upper ends of the first and second brackets 22 are connected to a portion of the baler housing containing the reciprocating plunger and its drive. The drive is typically provided with a Power Take Off (PTO) connection 26 (cf FIG. 1) for connecting the drive to the PTO of the towing vehicle. Each of the first and second brackets 22 extend upwards from the tongue 14 toward the baler housing at a substantially 45 degree angle and each is provided with an elongate window 24.

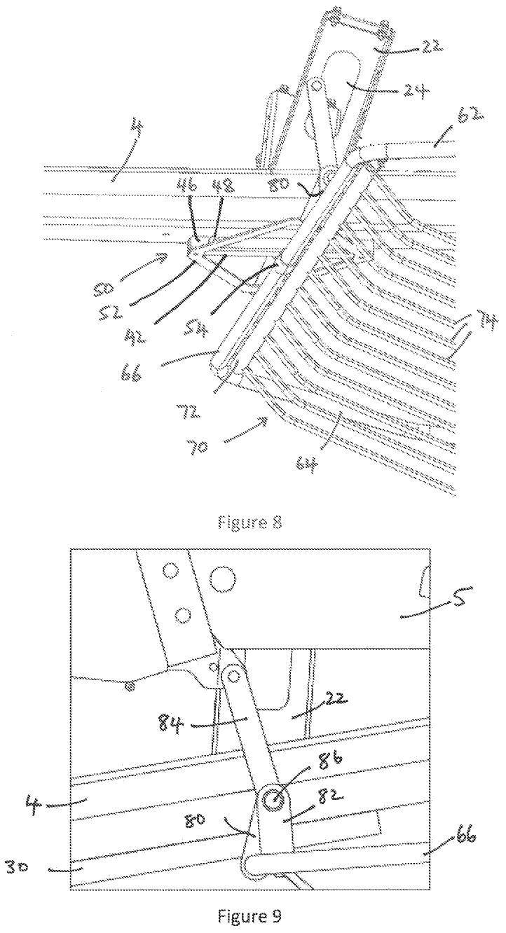

A guide channel 30 (omitted from FIGS. 5 and 8 for clarity) is provided extending fore and aft along a lower surface of the tongue 14. It will be understood that the guide channel 30 is mounted substantially in line with or along the central longitudinal axis of the agricultural baler 2. The guide channel 30 is substantially C-shaped with a central connecting portion 32 mounted to the underside of the tongue 30 in any suitable manner and first and second L-shaped flanges 34,36 extending along each side of the central connecting portion 32.

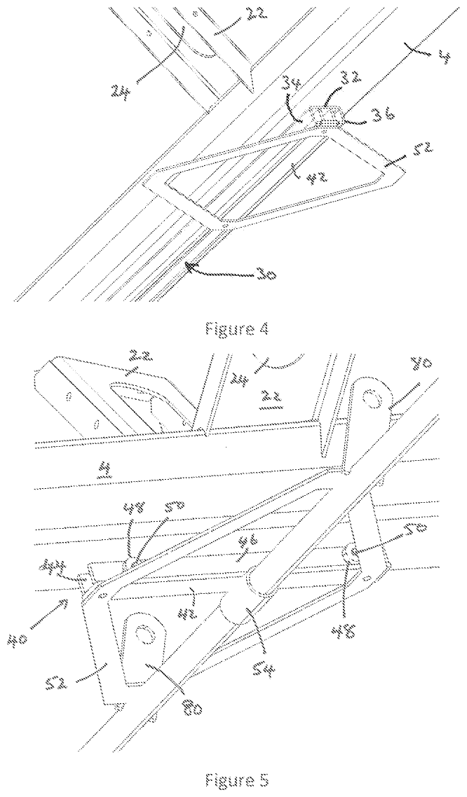

A carriage 40 is provided for displacement within the guide channel 30 (cf FIGS. 4 and 5). The carriage 40 comprises a longitudinally extending base element 42 on which are provided upwardly extending first and second side walls 44,46. Each of the first and second side walls 44,46 are provided with runners. In the illustrated embodiment, the runners take the form of rollers 48 mounted on the outside of the side walls 44,46. Each pair of rollers 48 is connected by an axle 50 extending through the side walls 44,46. The rollers may comprise any suitable material. In the illustrated embodiment two such sets of runners are provided.

A lower surface of the base element 42 is connected at each end to a support element 52. In the illustrated embodiment, the support element 52 is of trapezoidal form such that substantially triangular portions extend to each side of the base element 42 beneath the guide channel 30. A tubular support element 54 is provided on a central lower portion of the base element 42 (omitted from FIG. 4 for clarity).

In use, the runners are adapted to run within the L-shaped flanges 34,36 of the guide channel 30 with the base element 42 being located between free ends of the opposing L-shaped flanges 34,36. In this way the carriage 40 is adapted to slide within the guide channel 30. Conveniently a stop may be provided at each end of the guide channel 30 to prevent the carriage 40 from exiting the guide channel 30.

In order to control the flow of harvested crop material the agricultural baler 2 is provided with a windguard assembly. The windguard assembly includes the guide channel 30 and the carriage 40 as well as a windguard frame element 60 and a crop material hold down element 70 supported from the windguard frame element 60 to enable pivoting movement of the crop material hold down element 70 with respect to the windguard frame element 60.

The windguard frame element 60 comprises a pair of inverted, generally L-shaped support arms 62,64 as well as a transversely extending member 66 connecting second ends of the support arms 62,64. In a working position first ends of each of the support arms 62,64 are connected by suitable mounting means 68 to suitable mounting points provided on each side of the pickup housing 20. A central portion of the transversely extending member 66 extends through the tubular support element 54 of the carriage 40.

The crop material hold down element 70 comprises a laterally extending element 72 carrying a plurality of elongate fore and aft extending tines 74. The laterally extending element 72 is supported from the transversely extending member 66 of the windguard frame element 60 by a suitable linkage. The elongate tines 74 extend rearwardly from the laterally extending element 72 and present a suitable shape in order to direct harvested crop material towards the driven rotating tine rotor 18.

The transversely extending member 66 is provided with first and second upwardly extending tabs 80, one being located to each side of the tongue 14. As may be seen from FIGS. 5, 6 and 7 the tabs are located to be in the vicinity of the free ends of the triangular portions of the support element 52. The laterally extending element 72 is also provided with first and second upwardly extending tabs 82, one being located to each side of the tongue 14. The free ends of each of the upwardly extending tabs 80,82 are provided with openings.

First and second elongate support elements 84 are also provided, depending from the upper part 5 of the baler frame, one to each side of the tongue 14. Each of the upper and lower ends of the elongate support elements 84 are provided with openings.

Pivot pins 86 extend though the openings in the free ends of the tabs 80,82 as well as the lower ends of the support elements 84. This forms the linkage allowing the crop material hold down element 70 to pivot with respect to the windguard frame element 60 about an axis defined by and extending through the pivot pins 86.

The upper ends of the first and second elongate support elements 84 are connected to the upper part 5 of the baler frame (FIG. 9) for example to one of the outer casing elements.

In the event of a blockage in the pickup apparatus 8, or the need to perform servicing on aspects of the baler to which access is made difficult by the presence of the windguard frame element 60 and the crop material hold down element 70, the mounting means 68 securing the windguard frame element 60 to the pick up housing 20 are released and the lower ends of the support elements 84 disconnected from the free ends of each of the upwardly extending tabs 80,82 by releasing the pivot pins 86 from the lower ends of the support elements 84. This allows for the windguard frame element 60 and the crop material hold down element 70 to be displaced along the guide channel 30 away from the pickup apparatus 8 and toward the hitch 6. Once the blockage has been cleared the carriage 40 carrying the windguard frame element 60 and the crop material hold down element 70 may be guided back along the guide channel towards the pick up apparatus 8, so that the first ends of the windguard frame element 60 can be secured back to the pick up housing 20, and the free ends of each of the upwardly extending tabs 80,82 can be reconnected to the first and second support elements 84 to secure the windguard assembly element 60 and the hold down crop element 70 back into the working position.

All references cited herein are incorporated herein in their entireties. If there is a conflict between definitions herein and in an incorporated reference, the definition herein shall control.

From reading the present disclosure, other modifications will be apparent to persons skilled in the art. Such modifications may involve other features which are already known in the field of balers and component parts therefore and which may be used instead of or in addition to features already described herein.

1. A windguard assembly for use with an agricultural baler, the windguard assembly comprising a guide channel for connection to an agricultural baler, a carriage for displacement within the guide channel, a windguard frame element supported by the carriage and a crop material hold down element pivotally supported from the windguard frame element about a pivot axis wherein the guide channel includes L-shaped flanges adapted to support the carriage and allow for displacement of the carriage within the guide channel.

2. A windguard assembly according to claim 1, wherein the carriage further comprises side walls connected to a base element and runners supported by the side walls, the runners being housed with the guide channel.

3. A windguard assembly according to claim 1, wherein the windguard frame element is supported from the carriage and comprises first and second support arms connected by a transversely extending member.

4. A windguard assembly according to claim 1, wherein the windguard frame element is supported from the carriage and comprises first and second support arms connected by a transversely extending member.

5. A windguard assembly according to claim 4, wherein the carriage further comprises a tubular support element connected to a base of the carriage through which the transversely extending member extends.

6. A windguard assembly according to claim 1, wherein the crop material hold down element comprises a laterally extending element carrying a plurality of elongate tines.

7. A windguard assembly according to claim 6, wherein the laterally extending element of the crop material hold down element is supported from the transversely extending member of the windguard frame element by a linkage.

8. A windguard assembly according to claim 7 wherein the linkage comprises first and second tabs on the laterally extending element of the crop material hold down element, first and second tabs on the transversely extending member of the windguard frame element, upper ends of the respective first and second tabs being connected to one another by pivot pins to allow movement about the pivot axis.

9. A windguard assembly according to claim 1, wherein the assembly further comprises fasteners for releasably securing the windguard frame element to an agricultural baler.

10. An agricultural baler incorporating a windguard assembly according claim 1.

11. An agricultural baler according to claim 10, in which the baler comprises a baler frame having a lower part and support elements depending from the baler frame wherein the guide channel of the windguard assembly is secured to the lower part of the baler frame, the windguard frame element and the crop material hold down element are releasably connected to lower ends of the support elements and the baler further comprises a pickup apparatus having a pick up housing wherein the windguard frame element is releasably secured to the pick up housing.
